(19) United States
(12) Patent Application Publication
(10) Pub. No.: US 2026/0349924 A1
(43) Pub. Date: Nov. 5, 2026

(54) STACKED SET-ASSOCIATIVE CACHE LOOKUP

(71) Applicant: Arm Limited, Cambridge (GB)

(72) Inventors: Lilian Atieno HUTCHINS, Chandler, AZ (US); David MADSEN, Chandler, AZ (US); Richard F BRYANT, Chandler, AZ (US)

(21) Appl. No.: 19/198,233

(22) Filed: May 5, 2025

(51) Int. Cl. G06F 12/0864; G06F 12/0875; G06F 12/0895

(52) U.S. Cl. CPC G06F 12/0864; G06F 12/0875; G06F 12/0895

(57) ABSTRACT

An apparatus includes: shared set-associative cache storage circuitry configured to store entries, the shared set-associative cache storage circuitry accessible by a plurality of requesters; lookup circuitry configured to, responsive to a target address from a given requester of the plurality of requesters, perform a lookup of a stack of the entries in a given cycle, and perform a lookup of a different stack of the entries in a subsequent cycle, wherein the stack and the different stack are part of the same set of entries allowed to be allocated with entries data for the target address.

### BACKGROUND

### Technical Field

The present technique relates to the field of data processing.

### Technical Background

A set-associative cache may comprise a number of sets of cache entries. These cache entries may be looked up using an index value derived from a target address. The index value is used to select a set of cache entries, and tag values of the cache entries are compared with a tag portion of the target address to identify one or more matching cache entries.

### SUMMARY

At least some examples of the present technique provide an apparatus comprising: shared set-associative cache storage circuitry configured to store entries, the shared set-associative cache storage circuitry accessible by a plurality of requesters; lookup circuitry configured to, responsive to a target address from a given requester of the plurality of requesters, perform a lookup of a stack of the entries in a given cycle, and perform a lookup of a different stack of the entries in a subsequent cycle, wherein the stack and the different stack are part of the same set of entries allowed to be allocated with data for the target address.

At least some examples of the present technique provide a system comprising:
the apparatus described above, implemented in at least one packaged chip;
at least one system component; and
a board,
   wherein the at least one packaged chip and the at least one system component are assembled on the board.

At least some examples of the present technique provide a chip-containing product comprising the system described above, wherein the system is assembled on a further board with at least one other product component.

At least some examples of the present technique provide a non-transitory computer-readable medium storing computer-readable code for fabrication of an apparatus comprising: shared set-associative cache storage circuitry configured to store entries, the shared set-associative cache storage circuitry accessible by a plurality of requesters; lookup circuitry configured to, responsive to a target address from a given requester of the plurality of requesters, perform a lookup of a stack of the entries in a given cycle, and perform a lookup of a different stack of the entries in a subsequent cycle, wherein the stack and the different stack are part of the same set of entries allowed to be allocated with data for the target address.

At least some examples of the present technique provide a method comprising: performing, in response to a target address from a given requester of a plurality of requesters, a lookup in a given cycle of a stack of the entries stored by shared set-associative cache storage circuitry, the shared set-associative cache storage circuitry accessible by the plurality of requesters; and performing, a lookup in a subsequent cycle of a different stack of the entries stored by the shared set-associative cache storage circuitry, wherein the stack and the different stack are part of the same set allocated with entries for the target address.

Further aspects, features and advantages of the present technique will be apparent from the following description of examples, which is to be read in conjunction with the accompanying drawings.

### BRIEF DESCRIPTION OF THE DRAWINGS

FIG. 1 illustrates an example apparatus according to the present techniques;

FIG. 2 illustrates an example system in which the present techniques may be implemented;

FIG. 3 shows steps for performing lookups of cache entries across different cycles according to the present techniques;

FIG. 4 shows one way of performing a lookup of cache entries;

FIG. 5 shows an example way of performing a lookup of cache entries according to the present techniques;

FIG. 6 shows steps for returning a lookup response according to the present techniques;

FIG. 7 shows an example way of combining lookup results across different processing cycles;

FIG. 8 shows steps for biasing a lookup of stacks according to the present techniques;

FIG. 9 shows steps for duplicating entries across stacks associated with different requesters according to the present techniques; and

FIG. 10 illustrates a system and a chip-containing product.

### DESCRIPTION OF EXAMPLES

In the examples discussed below, there is provided an apparatus having shared set-associative cache storage circuitry configured to store entries, the shared set-associative cache storage circuitry accessible by a plurality of requesters.

The present inventors have identified that associativity of a cache can influence performance, such as cache hit rates, power consumption, and hardware cost. In particular, increased associativity can increase cache hit rates and reduce the likelihood for conflicts, whereas by increasing cache associativity, complexity and hardware costs are also increased. For example, a greater cache associativity results in an increase in the circuitry required for tag comparison. This is because a typical approach to accessing ways in a cache is to access all of the ways in parallel. For example, in a DRAM implementation, reads are destructive and thus only one line can be read at a time for a given bank of storage. Hence, independent banks of DRAM allow parallel lookups for each way to be performed. This results in a cache that is less area and power efficient as the associativity of the cache increases. However, the present inventors have identified that it would be useful to increase the effective associativity of a cache that is shared between multiple requesters without incurring the additional associated complexity, power consumption, and hardware cost.

Hence, in the examples discussed herein, the apparatus also comprises lookup circuitry configured to, responsive to a target address from a given requester of the plurality of requesters, perform a lookup of a stack of the entries in a given cycle, and perform a lookup of a different stack of the entries in a subsequent cycle, wherein the stack and the different stack are part of the same set of entries allowed to be allocated with data for the target address.

By performing lookups of different stacks of entries in different processing cycles, where the different stacks of entries are part of the same set of entries allowed to be allocated with data for the target address, the associativity of the shared cache can effectively be increased, while reducing the additional hardware penalty for performing additional tag comparisons. For example, for an 8-way set-associative cache implementation, by performing lookups of different stacks in different processing cycles, the associativity of the shared cache can effectively be increased to 16-way while only incurring the hardware cost of performing 9 tag comparisons (8 for each way in a stack and one for the result of the previous processing cycle). From one perspective, the present technique can be seen as a way of increasing associativity across time rather than in space. In this way, there can be a minor time cost in that in some cases it may take more than one cycle to hit on a cache entry (e.g. where the lookup in the first cycle misses and the lookup in the next cycle hits), depending on the number of stacks per set, but otherwise the associativity of the cache is effectively increased while reducing the associated hardware cost for doing so.

The present set-associative cache is a shared cache accessible by a plurality of requesters. This is because it can be particularly useful to increase the associativity of a shared cache that is shared between multiple requesters as this can help to increase performance as there is flexibility to allocate data for a given address to more locations, which reduces the likelihood of thrashing as it means more different addresses mapping to the same set can each be cached simultaneously. However, as discussed above, the additional circuitry cost of increasing associativity can be prohibitive. Hence, by combining the present approach to looking up stacks in the set in different processing cycles with a shared cache accessible to multiple requesters (such as processing cores), associativity of the cache and thus performance can be increased while reducing the hardware cost for doing so. This is particularly advantageous for a shared cache because the likelihood of thrashing is greater when a plurality of requesters has access to the cache, and the likelihood of thrashing increases as the number of requesters increases.

It will be appreciated that the lookup of the different stack of the entries in the subsequent may be responsive to a miss of the lookup of the stack of the entries in the given cycle, or it may be performed regardless of whether the first lookup results in a miss. For example, in some cases, all of the stack and the different stack may be looked up before determining whether the lookups hit or miss. This can vary depending on implementation.

In some examples, the lookup circuitry is configured to identify the stack and the different stack to be looked up based on the target address. This supports efficient stack determination.

In some examples, the lookup circuitry is configured to identify the stack to look up in the given cycle by determining a stack index based on the target address. This supports efficient determination of the first stack to lookup for a given target address. In some examples, the stack index may be derived from the target address.

In order to increase the likelihood that the number of cycles required to hit in the cache is less than a total number of stacks, and indeed to reduce the number of cycles required to hit in the cache, the stack to be looked up in the given cycle can be biased in various ways. Thus, in some examples, the lookup circuitry is configured to identify the stack to be looked up in the given cycle based on biasing information to bias the identification of the stack to be looked up in the given cycle. This reduces the likelihood that additional lookups and additional processing cycles will be required to determine a cache hit, and so performance is increased.

In some examples, the biasing information comprises a parameter associated with a request specifying the target address. Hence, the request itself can inform the first stack to be looked up in response to the request. This provides a controllable approach for biasing which stack is to be looked up first responsive to the request, as the parameter may be set by the requester.

In some examples, the biasing information is indicative of a default stack to be looked up in the given cycle. This can be an efficient mechanism for stack identification. In particular, in some implementations, a default stack having a particular stack index may always be looked up first.

In some examples, the biasing information is indicative of the given requester. Hence, different requesters may be biased in different ways. This can be useful with the shared cache, as different requesters can be biased differently to increase the likelihood that a lookup for a given requester hits in a first processing cycle. For example, different requesters may be preferentially allocated entries to certain stacks, and so by biasing the identification of the first stack to be looked up can increase the likelihood of a hit with the first lookup.

In some examples, the biasing information comprises stored history information associated with previous lookups of the entries. In some cases, there may be trends in requests from requesters, and so using stored history information can increase the likelihood of a hit with the first lookup.

In some examples, the lookup circuitry is configured to identify the stack to be looked up in the given cycle in response to determining that the stored history information indicates that a previous target address from the given requester corresponding to the target address hit on an entry in the stack. Hence, the likelihood that a later request targeting the same target address hits in the first stack looked up is increased.

In some examples, the lookup circuitry is configured to perform the lookups of the stack and different stack by comparing a tag value of each entry in the respective stack with a tag portion of the target address. In this way, an efficient hit/miss determination is supported.

In some examples, the plurality of requesters comprises a plurality of processing cores. Hence, the present techniques may be used with processing cluster implementations. As discussed above, this is particularly advantageous because the likelihood of thrashing is increased with a shared cache accessible by multiple processing cores, and so a greater associativity is beneficial to counteract this. As also discussed above, a greater associativity typically results in an associated increase in hardware, however, by effectively increasing the associativity with the present techniques this increase in hardware requirement can be reduced.

In some examples, the lookup circuitry is configured to, in the event of a hit when performing the lookup of the stack of the entries, return a response based on the hit to the given requester and suppress the lookup of the different stack in the subsequent cycle. Hence, processing resources can be preserved. In this case, the response may be provided in the given cycle or in a later cycle, depending on implementation. Indeed, it will be appreciated that the present disclosure is not particularly limited in this respect, and there may be some cases where the response is not able to be returned in the same cycle as the hit determination.

In some examples, the lookup circuitry is configured to, in the event of a hit when performing the lookup of the stack of the entries, return a response based on the hit to the given requester in the given cycle. Hence, the response may be returned in the same cycle as the lookup. This can be useful in time-critical implementations.

In some cases, once a lookup results in a hit, the response may be returned and no further lookups may be performed. In other cases, further lookups are performed irrespective of whether an earlier lookup results in a hit. The present disclosure is not particularly limited in this respect.

Indeed, alternatively, in some examples, the lookup circuitry is configured to return a response to the given requester in the subsequent cycle regardless of whether there is a hit in the given cycle. Hence, the response may be delayed until all of the stack and the different stack have been looked up. This can thus provide a flexible approach that may vary depending on implementation.

In some examples, the lookup circuitry is configured to determine the set, the set including the stack, the different stack and one or more other stacks, and wherein the lookup circuitry is configured to lookup each of the stacks in the set in different cycles. Hence, the number of stacks is not particularly limited and may vary depending on implementation. The lookup circuitry may be configured to lookup a plurality (such as more than two) of different stacks in different processing cycles.

In some examples, the lookup circuitry is configured to combine lookup results for each entry of the stack into a combined result in the given cycle, and combine the combined result with lookup results for each entry of the different stack in the subsequent cycle. In this way, a multiplexing requirement can be reduced by multiplexing the combined result from the first cycle with results from the second cycle. This can improve timing and reduce an area requirement of the arrangement by removing the need for additional multiplexing circuitry to support greater simultaneous multiplexing.

In some examples, the shared set-associative cache storage circuitry comprises an address translation cache to store the entries, each entry to store address translation data for a corresponding block of addresses, and wherein the target address is specified in a translation lookup request. Hence, the shared cache may be a translation lookaside buffer (TLB) that is shared between multiple requesters. The present inventors have identified that the present techniques are particularly well-suited to TLB implementations, because ways in TLBs are typically accessed in parallel, which makes a TLB less area and power efficient as associativity increases. Hence, the present approach of effectively increasing associativity without the associated area and power cost is particularly beneficial. Furthermore, the TLB implementation also reduces the impact of the time penalty associated with having to perform a further lookup in a later cycle when the first lookup misses, because if the lookups entirely miss in the TLB then the extra cycles for performing the later lookups in later cycles are small in comparison to the cost of having to perform a page table walk.

In some examples, the apparatus further comprises tracking circuitry to track cache entry access information indicative of whether a given entry is shared between multiple requesters, and wherein the lookup circuitry is configured to identify the stack to be looked up in the given cycle based on the entry access information. Such entry access information may be associated with common not private bits that track whether a given entry in a TLB is shared between multiple requesters. This can be used to inform the first lookup. In particular, if a given entry is shared between multiple requesters, the likelihood that the entry will be subsequently requested is increased and so it can be useful to bias lookups to stacks including that entry to reduce the number of cycles required to hit on the entry.

In some examples, the lookup circuitry is configured to, in response to determining that the entry access information indicates that a given entry for a given requester is shared with another requester, duplicate the given entry into a stack of the entries associated with the another requester. Hence, this can increase the likelihood of a hit with the first lookup for a given requester.

In some examples, the stack of the entries is associated with the given requester, and wherein the lookup circuitry is configured to preferentially allocate data associated with the given requester to a corresponding entry in the stack of the entries. Hence, the likelihood of a hit with the first lookup can be increased.

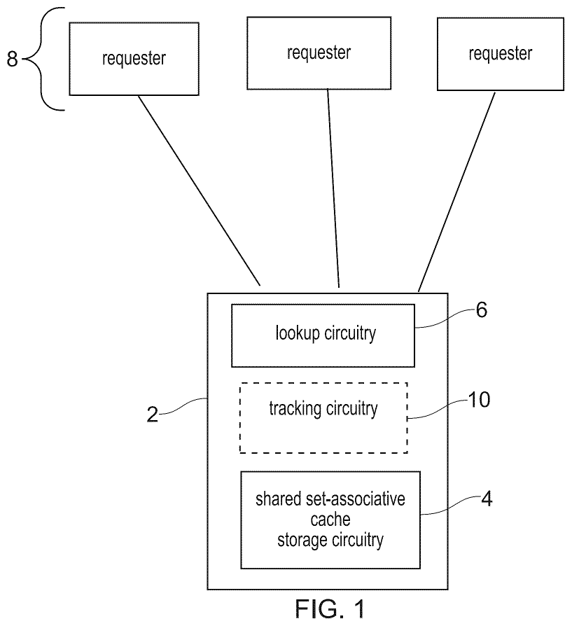

FIG. 1 schematically illustrates an example of a data processing apparatus 2 that may perform the present techniques. Data processing apparatus 2 includes shared set-associative cache storage circuitry 4 and lookup circuitry 6. Shared set-associative cache storage circuitry 4 stores cache entries and is accessible by a plurality of requesters 8. In this way, shared set-associative cache storage circuitry 4 is a shared cache.

Lookup circuitry 4 is configured to, responsive to a target address from a given requester of the plurality of requesters 8, perform a lookup of a stack of the entries in a given cycle, and perform a lookup of a different stack of the entries in a subsequent cycle, wherein the stack and the different stack are part of the same set of entries allowed to be allocated with data for the target address. As a result, the effective associativity of the shared cache (i.e. shared set-associative cache storage circuitry 4) is increased while reducing the circuitry cost for doing so. As a result of effectively increasing the associativity of the cache, cache performance can be increased.

Shared set-associative cache storage circuitry 4 is not overly limited and may include any form of cache for caching data/instructions. However, in some examples, the shared set-associative cache storage circuitry 4 comprises an address translation cache. In this way, the shared set-associative cache storage circuitry 4 may comprise a TLB. As discussed herein, the present technique may be particularly advantageous when the cache is a shared TLB shared between the plurality of requesters.

In some examples, the data processing apparatus 2 also includes tracking circuitry 10. Tracking circuitry 10 is configured to track cache entry access information indicative of whether a given entry is shared between multiple requesters. In such examples, the lookup circuitry 4 may be configured to identify the stack to be looked up in the given cycle based on the entry access information. It will be appreciated that tracking circuity 10 may be optional and in some cases is omitted entirely.

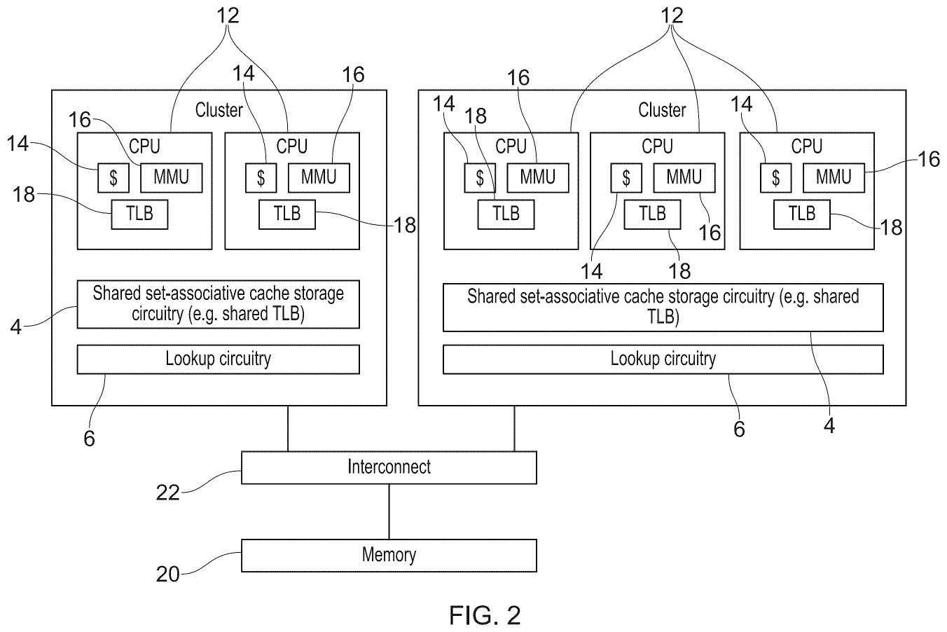

FIG. 2 illustrates an example system in which the present techniques may be implemented. In this example, the plurality of requesters 8 are a plurality of processing cores of a compute cluster, shown as CPUs 12. It will be appreciated that other requester devices may be provided instead. Each cluster may be provided with the shared set-associative cache storage circuitry 4 and lookup circuitry 6 of FIG. 1.

Each CPU 12 may have an instruction and/or data cache 14 for caching instructions or data local to the CPU. Coherency between data in the respective caches and accessed by the respective CPUs may be managed by a coherent interconnect 22 which tracks requests for accesses to data from a given address and controls snooping of data in other CPU's caches when required for maintaining coherency. It will be appreciated that in other embodiments such coherency operations could be managed in software, but a benefit of providing a hardware interconnect 22 for tracking such coherency is that the programmers of the software executed by the system do not need to consider coherency.

As shown in FIG. 2, the CPUs 12 may include a memory management unit (MMU) 16 which may include at least one address translation cache 18 (TLB) for caching address translation data used for translating addresses specified by the software into physical addresses referring to specific locations in memory 20.

As also shown in FIG. 2, each CPU 12 of a cluster has access to the shared set-associative cache storage circuitry 4. In this way, the shared set-associative cache storage circuitry 4 is shared between different processing cores of the cluster. In this example, each CPU 12 is provided with a TLB 18, and also has access to the shared set-associative cache storage circuitry 4, which may be a shared TLB. In other examples, the TLBs 18 in a cluster are omitted, and the shared TLB 4 is used by all CPUs 12 in the cluster.

As discussed in relation to FIG. 1, a requester, such as one of the CPUs 12 in a given cluster, may send a request to the lookup circuitry 6 specifying a target address. The lookup circuitry 6 is then configured to lookup the shared set-associative cache storage circuitry 4. In particular, the lookup circuitry 6 is configured to perform a lookup of a stack of the entries in a given cycle, and perform a lookup of a different stack of the entries in a subsequent cycle, wherein the stack and the different stack are part of the same set of entries allowed to be allocated with data for the target address.

It will be appreciated that the data processing system may include various other components which are not shown in FIG. 2.

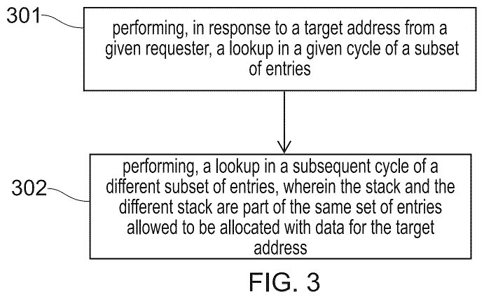

FIG. 3 shows steps for performing lookups of cache entries across different cycles according to the present techniques. The steps of FIG. 3 may be performed by lookup circuitry 6 from FIG. 1 or 2.

Step 301 includes performing, in response to a target address from a given requester, a lookup in a given cycle of a subset of entries. The entries being the cache entries stored by the shared set-associative cache storage circuitry 4.

Step 302 includes performing, a lookup in a subsequent cycle of a different subset of entries, wherein the stack and the different stack are part of the same set of entries allowed to be allocated with data for the target address.

In this way, different stacks of the same set are looked up in different cycles, thereby effectively increasing the associativity of the shared set-associative cache storage circuitry 4.

Step 302 may be performed responsive to determining a miss from the lookup of step 301, or in other examples step 302 may be performed irrespective of the lookup result from step 302. Indeed, in some cases, step 302 may be performed before a lookup result from step 301 has been determined. It will also be appreciated that step 302 in some cases may not be performed. For example, in some implementations, when the lookup from step 301 hits, step 302 may not be performed, but nevertheless the lookup circuitry has a configured to support step 302 should it be performed.

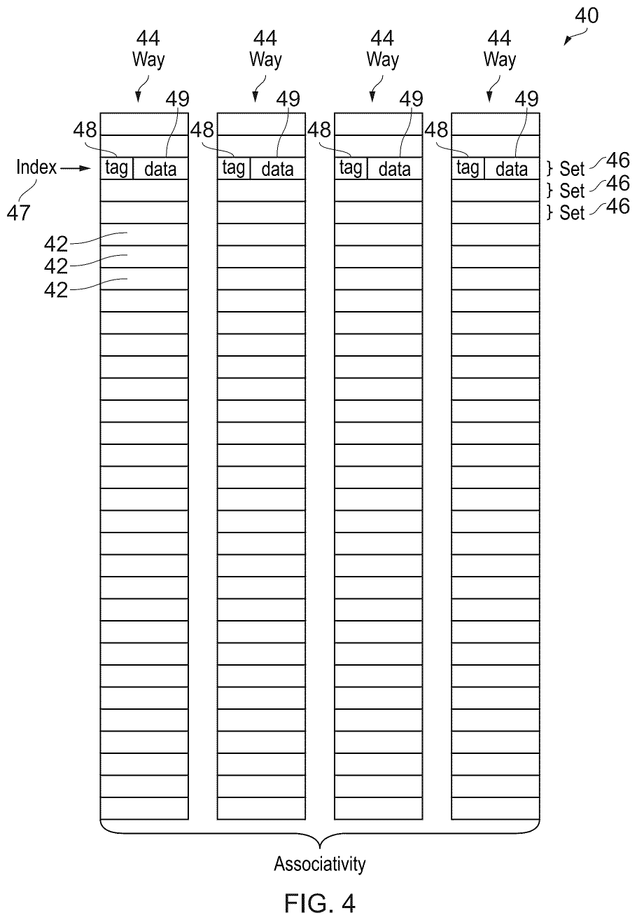

FIG. 4 shows one way of way of performing a lookup of cache entries in a set-associative cache.

As shown in FIG. 4, a set-associative cache 40 comprises a number of sets 46 of cache entries 42, each set 46 having two or more entries 42. For a cache having associativity A, this means that the number of entries in one set 46 is A. Such a cache can be described as an “A-way” set-associative cache and the entries can also be considered to be logically grouped into “ways” 44, where each set 46 comprises one entry 42 from each way 44. For example, a cache with 4 entries per set is 4-way set-associative. It will be appreciated that FIG. 4 merely shows the logical arrangement of the entries 42, and the physical arrangement of the entries 42 may be different. For example, “neighbouring” entries of the same set 46 or the same way 44 may in practice be arranged at separate physical locations in a memory device.

The set-associative placement policy used for such a cache means that when data having a given address needs to be allocated into the cache, it is placed in one of the entries 42 within a particular set 46 that is selected based on an index value 47 computed based on the given address. In some cases, the index value 47 may simply be a portion of bits extracted from the given address, while in other examples the index 47 could be based on a more complicated function of the given address (e.g. applying a hash function to the given address to obtain the index value 47). Hence, data associated with a given address cannot be stored in entries 42 of sets 46 other than the set corresponding to the index 47 selected based on the given address. This is useful because it reduces the number of entries of the cache which have to be checked to determine whether the cache stores data associated with a specified target address, but in comparison to a direct-mapped cache (where data for a given address can only be allocated to a single entry 42 selected based on the address), the set-associative placement scheme improves performance as there is flexibility to allocate data for a given address to two or more locations, which reduces the likelihood of thrashing as it means two or more different addresses mapping to the same set can each be cached simultaneously.

Each entry 42 may specify a cache tag value 48 and a data value 49. The data value 49 is the information of interest which is stored in the corresponding cache entry 42. The data value 49 could be data or instructions, or could be address mapping information cached in a translation lookaside buffer, for example. The tag 48 corresponds to a portion of the target address which is not used to generate the index, and is stored alongside the cached data 49 to allow the different addresses which map to the same index to be distinguished from each other when looking up in the cache. Each entry 42 may also store state information associated with the corresponding address, such as a valid indicator indicating whether the data in the corresponding entry 42 is valid, coherency state information (e.g. a dirty bit indicating whether the data value 49 has been modified compared to the corresponding data value in a higher level cache (e.g. L2 or L3 cache) or memory), or replacement policy information for selecting a victim cache entry when an entry needs to be evicted from the cache.

Hence, on a cache access to check whether data associated with a target address is stored in the cache, the index value 47 derived from the target address is used to select a set 46 and each of the tag values 48 in the entries 42 within the selected set 46 are compared with the tag portion of the target address. If any of the read tag values 48 match the tag portion of the target address then the corresponding cache entry 42 having the matching tag 48 stores the data for the requested target address, and that entry can be read or written depending on the type of access being performed. The scenario when one of the tags 48 in the indexed set 46 matches the tag of the target address is called a cache hit.

On the other hand, if none of the tags 48 in the indexed set 46 match the tag of the target address, then this is known as a cache miss, and in this case the information associated with the target address may need to be fetched from a further data store, such as a further level of cache or main memory. If one of the indexed set of caches is invalid, then the invalid entry can be selected for allocating the new data associated with a target address. However, if all of the indexed set of entries are already filled with valid data then one entry 42 of the indexed set 46 can be selected as a victim entry for which the data 49 is to be evicted from the cache to make way for the new information associated with the target address.

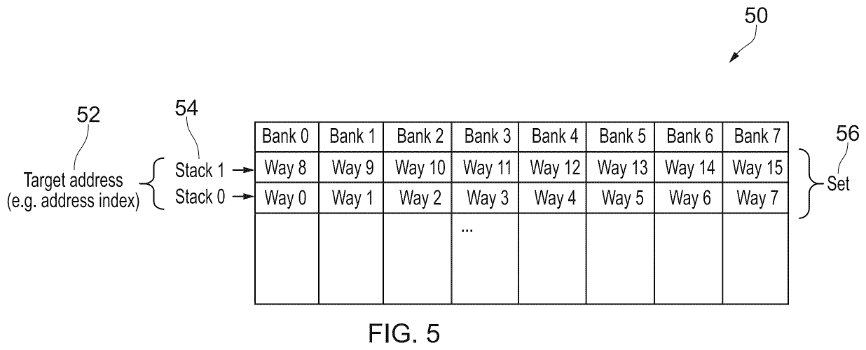

FIG. 5 shows an example approach to performing a lookup of cache entries according to the present techniques.

FIG. 5 shows a set-associative cache 50. Shared set-associative cache storage circuitry 4 may comprise the set-associative cache 50. Set-associative cache 50 is similar to set-associative cache 40 of FIG. 4, but differs in that multiple stacks of entries are part of the same set which are to be looked up in different processing cycles, as explained herein.

As shown, a target address 52 may be received from a given requester, such as of the plurality of requesters 8, 12 of FIGS. 1 and 2. Like in FIG. 4, the target address 52 may be used to determine the stacks 54 which correspond to the same set 56. More particularly, stack 0 and stack 1 are different stacks of cache entries which are part of the same set 56 allowed to be allocated with data for the target address 52. Stacks 54 may be identified by a stack index, for example determined from the target address.

As shown, each stack 54 includes a number of ways, in this example eight. As for FIG. 4, each way includes a tag and data portion. The ways are stored in individual banks of memory, which in this case is DRAM. As discussed above, reads in DRAM memory are destructive, and thus only one line can be read at a time for a given bank of storage. Hence, independent banks of DRAM allow parallel lookups for each way to be performed. This results in a cache that is less area and power efficient as the associativity of the cache increases.

As shown, from the same target address 52, a plurality of stacks 54 corresponding to the same set 56 can be identified. That is to say, stack 0 and stack 1 in FIG. 5 are part of the same set of entries allowed to be allocated with data for the target address. The lookup circuitry 4 is configured to perform a lookup of a first of the stacks in a first processing cycle, and the second of the stacks in a second processing cycle. In this way, the associativity of the cache 50 is effectively increased.

Indeed, in contrast to the cache 40 of FIG. 4, cache 50 of FIG. 5 includes a plurality of stacks of entries corresponding to the same set 56, which are to be looked up in different processing cycles. In this example of two stacks per set, this results in a doubling of the associativity of the cache 50. However, it will be appreciated that the number of stacks of the same set is not particularly limited and may be a number greater than two in some cases.

The way the stacks 54 are identified from the target address 52 is not particularly limited. In some cases, each stack 54 may have an associated stack index that may be derived from the target address 52. The stack index may then be used to identify the stack of entries in the cache 50. For example, the stack index may simply be a portion of bits extracted from the target address or an augmented form of the target address, while in other examples the stack index could be based on a more complicated function of the target address (e.g. applying a hash function to the target address to obtain the stack index). In some cases, an address index is derived from the target address, and the stack indexes are derived from the address index. In other cases, the stack indexes may be determined directly from the target address.

The stack to be looked up first can be determined in a number of ways. In some examples, the stack to be looked up in a given cycle is based on a default stack to be looked up. For example, stack 0 (or the stack having the lowest stack index) may be looked up first, and then the stacks may be iterated through until all stacks have been looked up (or a hit has been determined). In some cases, the given requester informs the identification of which stack is to be looked up first. For example, different requesters may be assigned different default stacks to be looked up first responsive to a target address.

In some cases, the stack to be looked up in a given cycle is identified based on biasing information to bias the identification. The biasing information is not particularly limited. By biasing the identification, the likelihood of a hit from the lookup in the first cycle can be increased, and thus performance can be increased. The biasing information may be indicative of an identity of the given requester. The biasing information may include stored history information associated with previous lookups of the entries. In some cases, the biasing information can include a parameter associated with a request specifying the target address. Hence, the identification of the first stack to lookup responsive to the target address may be biased in various ways. By biasing the first stack lookup, the likelihood that the first stack that is looked up results in a hit can be increased. Hence, the time to determine a hit result can be reduced, and the likelihood of a time penalty being incurred by having to perform subsequent lookups in subsequent processing cycles can be reduced. This increases performance.

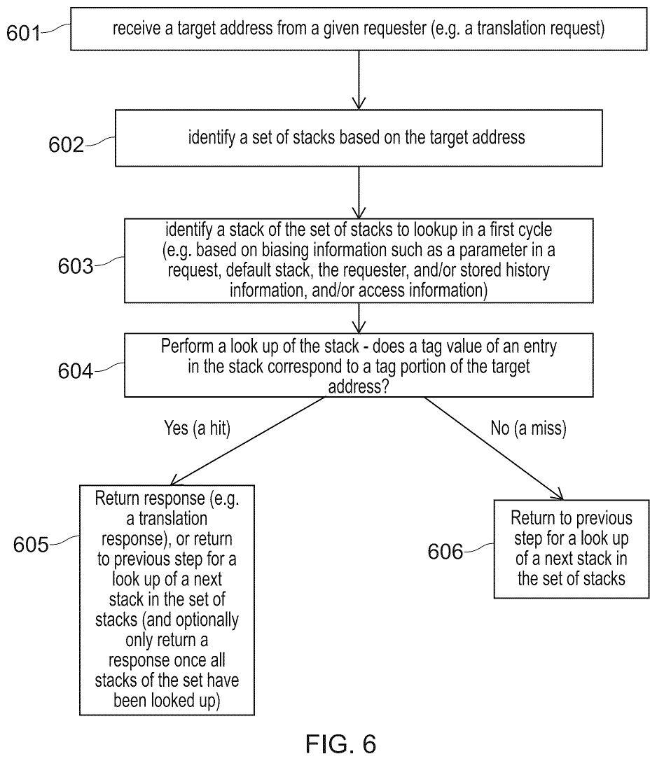

FIG. 6 shows steps for returning a lookup response according to the present techniques. For example, in implementations where the shared set-associative cache storage circuitry stores a shared TLB (i.e. an address translation cache), the response may be a translation response which is returned responsive to a translation request from a given requester.

At step 601, a target address is received from a given requester, such as a requester of the plurality of requesters 8, 12, of FIG. 1 or 2. In an address translation cache implementation, step 601 may include receiving a translation request specifying a target address. At step 602, a set of stacks is identified based on the target address. As discussed herein, a hash function may be applied to the target address to determine stack indexes of the stacks corresponding to the same set. The stack index may then be used to index into the cache to determine the stack of entries.

At step 603, a stack of the set of stacks to lookup in a first processing cycle is identified. As discussed herein, this may be based on biasing information which biases the identification. For example, this may be based on a parameter of a request specifying the target address (such as a translation request). In some cases, this may be based on a default stack that is to be looked up first for the given target address or the given requester. The biasing information may include an identity of the given requester. Hence, the stack to lookup first for a particular requester may be based on the identity of the particular requester, allowing the stack to be looked up first to be different for different requesters. Where there is a dependence between the requester and which stack is more likely to contain an entry that hits, this can increase the likelihood that the first lookup hits and thus can improve performance.

In some cases, the biasing information can include stored history information associated with previous lookups of the entries. For example, for a given requester, the stored history information may indicate that the first lookup is more likely to hit in a certain stack, and so the first stack to be looked up can be biased to be that certain stack. This can increase the likelihood of a hit with the first lookup.

At step 604, a look up of the stack identified at step 603 is performed. This can include checking whether a tag value of an entry in the stack corresponds to a tag portion of the target address, as discussed further above.

If the look up from step 604 hits, i.e. when a tag value of an entry in the stack does correspond to a tag portion of the target address, the process continues to step 605. At step 605, depending on implementation, a response is returned and the process is complete or the process returns to step 604 and the next stack in the set of stacks is looked up. Optionally, the response may be delayed until all stacks in the set have been looked up.

If the look up from step 604 misses, i.e. when a tag value of an entry in the stack does not correspond to a tag portion of the target address, the process continues to step 606. At step 606, the process returns to step 604 for a look up of the next stack in the set of stacks.

The next stack to be looked up may be based on a default assignment, or may be biased in a similar way as for the first stack that is to be looked up responsive to the target address. In some cases, the next stack is identified based on a sequence of stack indexes. For example, the stack indexes may be iterated through until all stacks in the set have been looked up.

In some cases, the process may perform the lookup for the next stack in the set of stacks regardless of the result of the first look up at step 604.

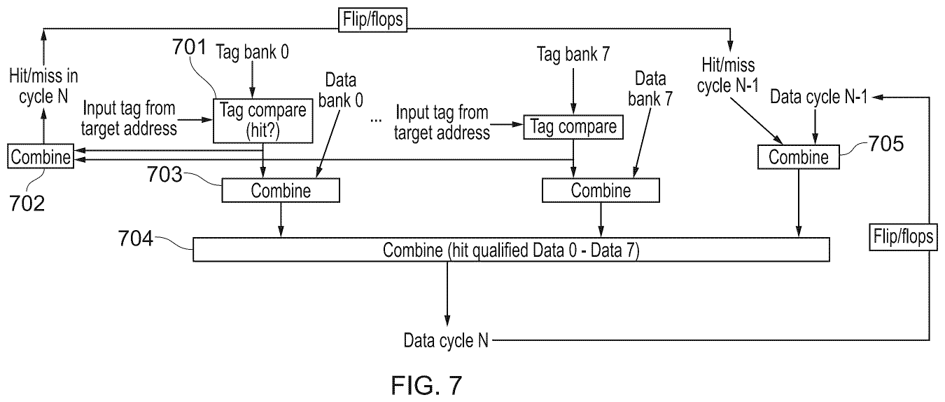

FIG. 7 shows an example way of combining lookup results across different processing cycles to reduce the amount of multiplexing required to provide a given level of associativity. In this example, there are eight banks of memory, each including one way having a cache entry comprising a tag and data (as described in relation to FIGS. 4 and 5). Using the present techniques, in this example, 16-way associativity is provided while requiring only the multiplexing for 9-way associativity (e.g. the 8-way of a stack being combined with a result from a previous cycle).

At 701, an input tag from a target address is compared to a tag from each of the memory banks (shown as ‘tag bank 0 ’ to ‘tag bank 7’). The tag from each way is compared to the input tag from the target address to determine whether any of the tags correspond to the input tag (i.e. whether there are one or more hits). The results from this step are combined into a hit/miss result for cycle N at 702.

At 703, for each of the banks, the result of the tag comparison is combined with the data from the respective bank. At 704, the results of the combination of 703 are combined with a combination of the hit/miss result (e.g. 702) and data from a previous cycle N-1 (having been combined at 705).

Hence, instead of multiplexing all ways in parallel, the lookup results for each entry of the stack are combined into a combined result in cycle N-1, and this combined result is combined with lookup results for each entry of the different stack in cycle N. This reduces the multiplexing required for a given associativity, thereby improving timing and reducing a circuit area requirement of the apparatus.

In a translation implementation where the page size determines that the physical address is equal to the virtual address, the virtual address can be pre-multiplexed during the first cycle look up by adding only a single 2:1 multiplexer on a non-timing critical path. This can also improve timing and reduce an area requirement.

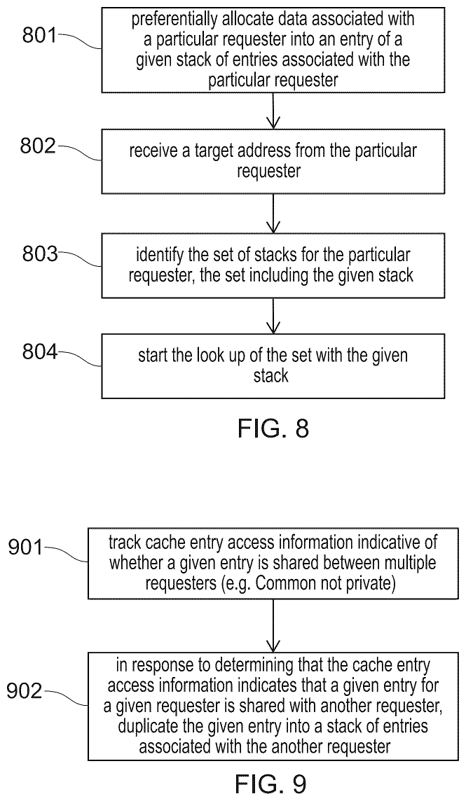

FIG. 8 shows steps for preferentially allocating data for a given requester and biasing a lookup of stacks according to the present techniques.

At step 801, data associated with a particular requester is preferentially allocated into an entry of a given stack associated with the particular requester. For example, a particular requester may be assigned a default stack of entries for data to be allocated into. Different requesters may be assigned different default stacks. At step 802, a target address is received from the particular requester. At step 803, the set of stacks is identified which includes the given stack from step 803. At step 804, the look up of the set is started from the given stack. Step 804 may include identifying the given stack as the stack to start the look up from, based on biasing information indicating that data associated with the particular requester has been preferentially allocated into the given stack. In this way, the likelihood of a hit with the first look up is increased, and so performance can be increased. The lookup process may finish once a hit result is identified.

FIG. 9 shows steps for duplicating entries across stacks associated with different requesters according to the present techniques. At step 901, cache entry access information indicative of whether a given entry is shared between multiple requesters is tracked. The tracking circuitry 10 from FIG. 1 may track the cache entry access information.

For example, the cache entry access information may comprise so-called common not private information, which indicates whether a TLB entry is shared between multiple requesters. At step 902, in response to determining that the cache entry access information indicates that a given entry for a given requester is shared with another requester, the given entry is duplicated into a stack of entries associated with the another requester. In this way, cache entries which are shared between different requesters may be duplicated across stacks associated with the different requesters to increase the likelihood of a hit with the look up for the different requesters. For example, if a given requester has an associated stack of entries, the shared entry may be duplicated into the associated stack of entries, and the lookup may be biased to start by looking up first the associated stack of entries.

Concepts described herein may be embodied in a system comprising at least one packaged chip. The apparatus described earlier is implemented in the at least one packaged chip (either being implemented in one specific chip of the system, or distributed over more than one packaged chip). The at least one packaged chip is assembled on a board with at least one system component. A chip-containing product may comprise the system assembled on a further board with at least one other product component. The system or the chip-containing product may be assembled into a housing or onto a structural support (such as a frame or blade).

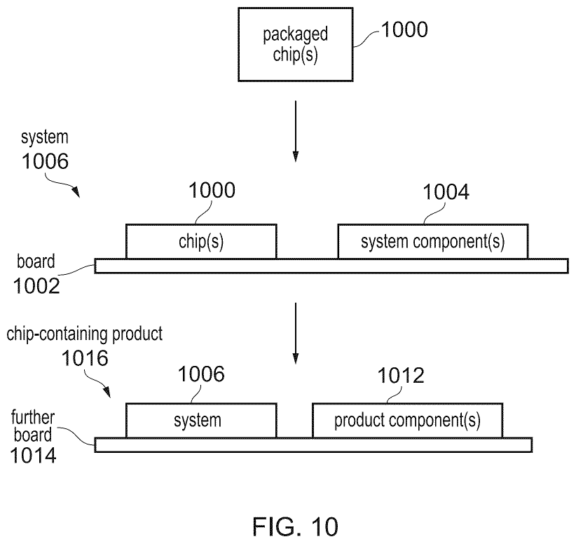

As shown in FIG. 10, one or more packaged chips 1000, with the apparatus described above implemented on one chip or distributed over two or more of the chips, are manufactured by a semiconductor chip manufacturer. In some examples, the chip product 1000 made by the semiconductor chip manufacturer may be provided as a semiconductor package which comprises a protective casing (e.g. made of metal, plastic, glass or ceramic) containing the semiconductor devices implementing the apparatus described above and connectors, such as lands, balls or pins, for connecting the semiconductor devices to an external environment. Where more than one chip 1000 is provided, these could be provided as separate integrated circuits (provided as separate packages), or could be packaged by the semiconductor provider into a multi-chip semiconductor package (e.g. using an interposer, or by using three-dimensional integration to provide a multi-layer chip product comprising two or more vertically stacked integrated circuit layers).

In some examples, a collection of chiplets (i.e. small modular chips with particular functionality) may itself be referred to as a chip. A chiplet may be packaged individually in a semiconductor package and/or together with other chiplets into a multi-chiplet semiconductor package (e.g. using an interposer, or by using three-dimensional integration to provide a multi-layer chiplet product comprising two or more vertically stacked integrated circuit layers).

The one or more packaged chips 1000 are assembled on a board 1002 together with at least one system component 1004 to provide a system 1006. For example, the board may comprise a printed circuit board. The board substrate may be made of any of a variety of materials, e.g. plastic, glass, ceramic, or a flexible substrate material such as paper, plastic or textile material. The at least one system component 1004 comprise one or more external components which are not part of the one or more packaged chip(s) 1000. For example, the at least one system component 404 could include, for example, any one or more of the following: another packaged chip (e.g. provided by a different manufacturer or produced on a different process node), an interface module, a resistor, a capacitor, an inductor, a transformer, a diode, a transistor and/or a sensor.

A chip-containing product 1016 is manufactured comprising the system 1006 (including the board 1002, the one or more chips 1000 and the at least one system component 1004) and one or more product components 1012. The product components 1012 comprise one or more further components which are not part of the system 1006. As a non-exhaustive list of examples, the one or more product components 1012 could include a user input/output device such as a keypad, touch screen, microphone, loudspeaker, display screen, haptic device, etc. ; a wireless communication transmitter/receiver; a sensor; an actuator for actuating mechanical motion; a thermal control device; a further packaged chip; an interface module; a resistor; a capacitor; an inductor; a transformer; a diode; and/or a transistor. The system 1006 and one or more product components 1012 may be assembled on to a further board 1014.

The board 1002 or the further board 1014 may be provided on or within a device housing or other structural support (e.g. a frame or blade) to provide a product which can be handled by a user and/or is intended for operational use by a person or company.

The system 1006 or the chip-containing product 1016 may be at least one of: an end-user product, a machine, a medical device, a computing or telecommunications infrastructure product, or an automation control system. For example, as a non-exhaustive list of examples, the chip-containing product could be any of the following: a telecommunications device, a mobile phone, a tablet, a laptop, a computer, a server (e.g. a rack server or blade server), an infrastructure device, networking equipment, a vehicle or other automotive product, industrial machinery, consumer device, smart card, credit card, smart glasses, avionics device, robotics device, camera, television, smart television, DVD players, set top box, wearable device, domestic appliance, smart meter, medical device, heating/lighting control device, sensor, and/or a control system for controlling public infrastructure equipment such as smart motorway or traffic lights.

Concepts described herein may be embodied in computer-readable code for fabrication of an apparatus that embodies the described concepts. For example, the computer-readable code can be used at one or more stages of a semiconductor design and fabrication process, including an electronic design automation (EDA) stage, to fabricate an integrated circuit comprising the apparatus embodying the concepts. The above computer-readable code may additionally or alternatively enable the definition, modelling, simulation, verification and/or testing of an apparatus embodying the concepts described herein.

For example, the computer-readable code for fabrication of an apparatus embodying the concepts described herein can be embodied in code defining a hardware description language (HDL) representation of the concepts. For example, the code may define a register-transfer-level (RTL) abstraction of one or more logic circuits for defining an apparatus embodying the concepts. The code may define a HDL representation of the one or more logic circuits embodying the apparatus in Verilog, SystemVerilog, Chisel, or VHDL (Very High-Speed Integrated Circuit Hardware Description Language) as well as intermediate representations such as FIRRTL. Computer-readable code may provide definitions embodying the concept using system-level modelling languages such as SystemC and SystemVerilog or other behavioural representations of the concepts that can be interpreted by a computer to enable simulation, functional and/or formal verification, and testing of the concepts.

Additionally or alternatively, the computer-readable code may define a low-level description of integrated circuit components that embody concepts described herein, such as one or more netlists or integrated circuit layout definitions, including representations such as GDSII. The one or more netlists or other computer-readable representation of integrated circuit components may be generated by applying one or more logic synthesis processes to an RTL representation to generate definitions for use in fabrication of an apparatus embodying the invention. Alternatively or additionally, the one or more logic synthesis processes can generate from the computer-readable code a bitstream to be loaded into a field programmable gate array (FPGA) to configure the FPGA to embody the described concepts. The FPGA may be deployed for the purposes of verification and test of the concepts prior to fabrication in an integrated circuit or the FPGA may be deployed in a product directly.

The computer-readable code may comprise a mix of code representations for fabrication of an apparatus, for example including a mix of one or more of an RTL representation, a netlist representation, or another computer-readable definition to be used in a semiconductor design and fabrication process to fabricate an apparatus embodying the invention. Alternatively or additionally, the concept may be defined in a combination of a computer-readable definition to be used in a semiconductor design and fabrication process to fabricate an apparatus and computer-readable code defining instructions which are to be executed by the defined apparatus once fabricated.

Such computer-readable code can be disposed in any known transitory computer-readable medium (such as wired or wireless transmission of code over a network) or non-transitory computer-readable medium such as semiconductor, magnetic disk, or optical disc. An integrated circuit fabricated using the computer-readable code may comprise components such as one or more of a central processing unit, graphics processing unit, neural processing unit, digital signal processor or other components that individually or collectively embody the concept.

Some examples are set out in the following clauses:

1. An apparatus comprising:
shared set-associative cache storage circuitry configured to store entries, the shared set-associative cache storage circuitry accessible by a plurality of requesters;
lookup circuitry configured to, responsive to a target address from a given requester of the plurality of requesters, perform a lookup of a stack of the entries in a given cycle, and perform a lookup of a different stack of the entries in a subsequent cycle, wherein the stack and the different stack are part of the same set of entries allowed to be allocated with data for the target address.

2. The apparatus of clause 1, wherein the lookup circuitry is configured to identify the stack and the different stack to be looked up based on the target address.

3. The apparatus of any preceding clause, wherein the lookup circuitry is configured to identify the stack to look up in the given cycle by determining a stack index based on the target address.

4. The apparatus of any preceding clause, wherein the lookup circuitry is configured to identify the stack to be looked up in the given cycle based on biasing information to bias the identification of the stack to be looked up in the given cycle.

5. The apparatus of clause 4, wherein the biasing information comprises a parameter associated with a request specifying the target address.

6. The apparatus of any of clauses 4 or 5, wherein the biasing information is indicative of a default stack to be looked up in the given cycle.

7. The apparatus of any of clauses 4 to 6, wherein the biasing information is indicative of the given requester.

8. The apparatus of any of clauses 4 to 7, wherein the biasing information comprises stored history information associated with previous lookups of the entries.

9. The apparatus of clause 8, wherein the lookup circuitry is configured to identify the stack to be looked up in the given cycle in response to determining that the stored history information indicates that a previous target address from the given requester corresponding to the target address hit on an entry in the stack.

10. The apparatus of any preceding clause, wherein the lookup circuitry is configured to perform the lookups of the stack and different stack by comparing a tag value of each entry in the respective stack with a tag portion of the target address.

11. The apparatus of any preceding clause, wherein the plurality of requesters comprises a plurality of processing cores.

12. The apparatus of any preceding clause, wherein the lookup circuitry is configured to, in the event of a hit when performing the lookup of the stack of the entries, return a response based on the hit to the given requester and suppress the lookup of the different stack in the subsequent cycle.

13. The apparatus of any of clauses 1 to 11, wherein the lookup circuitry is configured to return a response to the given requester in the subsequent cycle regardless of whether there is a hit in the given cycle.

14. The apparatus of any preceding clause, wherein the lookup circuitry is configured to determine the set, the set including the stack, the different stack and one or more other stacks, and wherein the lookup circuitry is configured to lookup each of the stacks in the set in different cycles.

15. The apparatus of any preceding clause, wherein the lookup circuitry is configured to combine lookup results for each entry of the stack into a combined result in the given cycle, and combine the combined result with lookup results for each entry of the different stack in the subsequent cycle.

16. The apparatus of any preceding clause, wherein the shared set-associative cache storage circuitry comprises an address translation cache to store the entries, each entry to store address translation data for a corresponding block of addresses, and wherein the target address is specified in a translation lookup request.

17. The apparatus of any preceding clause, further comprising tracking circuitry to track cache entry access information indicative of whether a given entry is shared between multiple requesters, and wherein the lookup circuitry is configured to identify the stack to be looked up in the given cycle based on the entry access information.

18. The apparatus of clause 17, wherein the lookup circuitry is configured to, in response to determining that the entry access information indicates that a given entry for a given requester is shared with another requester, duplicate the given entry into a stack of the entries associated with the another requester.

19. The apparatus of any preceding clause, wherein the stack of the entries is associated with the given requester, and wherein the lookup circuitry is configured to preferentially allocate data associated with the given requester to a corresponding entry in the stack of the entries.

20. A system comprising:
the apparatus of clause 1, implemented in at least one packaged chip;
at least one system component; and
a board,
wherein the at least one packaged chip and the at least one system component are assembled on the board.

21. A chip-containing product comprising the system of clause 20, wherein the system is assembled on a further board with at least one other product component.

22. A non-transitory computer-readable medium storing computer-readable code for fabrication of the apparatus of claim 1.

23. A method comprising:
performing, in response to a target address from a given requester of a plurality of requesters, a lookup in a given cycle of a stack of the entries stored by shared set-associative cache storage circuitry, the shared set-associative cache storage circuitry accessible by the plurality of requesters; and
performing, a lookup in a subsequent cycle of a different stack of the entries stored by the shared set-associative cache storage circuitry, wherein the stack and the different stack are part of the same set allocated with entries for the target address.

In the present application, the words “configured to . . . ” are used to mean that an element of an apparatus has a configuration able to carry out the defined operation. In this context, a “configuration” means an arrangement or manner of interconnection of hardware or software. For example, the apparatus may have dedicated hardware which provides the defined operation, or a processor or other processing device may be programmed to perform the function. “Configured to” does not imply that the apparatus element needs to be changed in any way in order to provide the defined operation.

In the present application, lists of features preceded with the phrase “at least one of” mean that any one or more of those features can be provided either individually or in combination. For example, “at least one of: A, B and C” encompasses any of the following options: A alone (without B or C), B alone (without A or C), C alone (without A or B), A and B in combination (without C), A and C in combination (without B), B and C in combination (without A), or A, B and C in combination.

Although illustrative embodiments of the invention have been described in detail herein with reference to the accompanying drawings, it is to be understood that the invention is not limited to those precise embodiments, and that various changes and modifications can be effected therein by one skilled in the art without departing from the scope of the invention as defined by the appended claims.

1. An apparatus comprising:
shared set-associative cache storage circuitry configured to store entries, the shared set-associative cache storage circuitry accessible by a plurality of requesters;
lookup circuitry configured to, responsive to a target address from a given requester of the plurality of requesters, perform a lookup of a stack of the entries in a given cycle, and perform a lookup of a different stack of the entries in a subsequent cycle, wherein the stack and the different stack are part of the same set of entries allowed to be allocated with data for the target address.

2. The apparatus of claim 1, wherein the lookup circuitry is configured to identify the stack and the different stack to be looked up based on the target address.

3. The apparatus of claim 1, wherein the lookup circuitry is configured to identify the stack to be looked up in the given cycle based on biasing information to bias the identification of the stack to be looked up in the given cycle.

4. The apparatus of claim 3, wherein the biasing information comprises a parameter associated with a request specifying the target address.

5. The apparatus of any claim 3, wherein the biasing information is indicative of a default stack to be looked up in the given cycle.

6. The apparatus of claim 3, wherein the biasing information is indicative of the given requester.

7. The apparatus of claim 3, wherein the biasing information comprises stored history information associated with previous lookups of the entries.

8. The apparatus of claim 7, wherein the lookup circuitry is configured to identify the stack to be looked up in the given cycle in response to determining that the stored history information indicates that a previous target address from the given requester corresponding to the target address hit on an entry in the stack.

9. The apparatus of claim 1, wherein the lookup circuitry is configured to perform the lookups of the stack and different stack by comparing a tag value of each entry in the respective stack with a tag portion of the target address.

10. The apparatus of claim 1, wherein the lookup circuitry is configured to, in the event of a hit when performing the lookup of the stack of the entries, return a response based on the hit to the given requester and suppress the lookup of the different stack in the subsequent cycle.

11. The apparatus of claim 1, wherein the lookup circuitry is configured to return a response to the given requester in the subsequent cycle regardless of whether there is a hit in the given cycle.

12. The apparatus of claim 1, wherein the lookup circuitry is configured to combine lookup results for each entry of the stack into a combined result in the given cycle, and combine the combined result with lookup results for each entry of the different stack in the subsequent cycle.

13. The apparatus of claim 1, wherein the shared set-associative cache storage circuitry comprises an address translation cache to store the entries, each entry to store address translation data for a corresponding block of addresses, and wherein the target address is specified in a translation lookup request.

14. The apparatus of claim 1, further comprising tracking circuitry to track cache entry access information indicative of whether a given entry is shared between multiple requesters, and wherein the lookup circuitry is configured to identify the stack to be looked up in the given cycle based on the entry access information.

15. The apparatus of claim 14, wherein the lookup circuitry is configured to, in response to determining that the entry access information indicates that a given entry for a given requester is shared with another requester, duplicate the given entry into a stack of the entries associated with the another requester.

16. The apparatus of claim 1, wherein the stack of the entries is associated with the given requester, and wherein the lookup circuitry is configured to preferentially allocate data associated with the given requester to a corresponding entry in the stack of the entries.

17. A system comprising:
the apparatus of claim 1, implemented in at least one packaged chip;
at least one system component; and
a board,
wherein the at least one packaged chip and the at least one system component are assembled on the board.

18. A chip-containing product comprising the system of claim 17, wherein the system is assembled on a further board with at least one other product component.

19. A non-transitory computer-readable medium storing computer-readable code for fabrication of the apparatus of claim 1.

20. A method comprising:
performing, in response to a target address from a given requester of a plurality of requesters, a lookup in a given cycle of a stack of the entries stored by shared set-associative cache storage circuitry, the shared set-associative cache storage circuitry accessible by the plurality of requesters; and
performing, a lookup in a subsequent cycle of a different stack of the entries stored by the shared set-associative cache storage circuitry, wherein the stack and the different stack are part of the same set allocated with entries for the target address.
